(19) United States
(12) Patent Application Publication
(10) Pub. No.: US 2008/0184914 A1
(43) Pub. Date: Aug. 7, 2008

(54) Process for Forming Dispersant-Coated Carbon Particles

(75) Inventors: Zhigang Shen, Singapore (SG); Jimmy Sung Lai Yun, Singapore (SG); Jiangfeng Chen, Singapore (SG)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Nanomaterials Technology PTE Ltd., Singapore (SG)

(21) Appl. No.: 11/914,812

(22) PCT Filed: Jun. 5, 2006
(86) PCT No.: PCT/SG06/00141

§ 371 Date: Mar. 26, 2008

(30) Foreign Application Priority Data
Jun. 7, 2005 (SG) 200503572-0

(51) Int. Cl. C09C 1/48; C08K 9/08

(52) U.S. Cl. 106/476; 106/472; 524/495

(57) ABSTRACT

A process of making dispersant-coated carbon particles comprising the steps of providing a liquid mixture comprising carbon particles and a dispersant, and imparting a shear force to the liquid mixture to thereby form said dispersant-coated carbon particles.

### TECHNICAL FIELD

The present invention generally relates to a process for forming dispersant-coated carbon particles.

### BACKGROUND

Carbon particles, in particular nano-sized carbon black particles, are commonly used as material fillers, as material-enhancers or in high-performance lithium-ion batteries.

A form of carbon is “carbon black”. Most types of carbon black contain over 97 to 99% elemental carbon. Carbon blacks are powdered forms of highly dispersed elemental carbon manufactured by controlled vapour-phase pyrolysis of hydrocarbons. Average particle diameters in several commercially-produced carbon blacks range from 0.01 to 0.4 micrometers (μm). Carbon black particles tend to bind into larger aggregate particles having diameters which range from 0.1 to 8.0 μm. These aggregated particles also tend to have a wide particle size distribution.

It is desirable in certain applications for carbon black particles to have a relatively uniform particle size within a narrow particle size distribution. However, as mentioned above, carbon black particles are not well dispersed and have a tendency to aggregate into larger particle bodies. This aggregation is believed to occur due to the carbon black particles having a high oil-absorbance and low surface charge.

To overcome this, the carbon particles can be coated with a dispersant to reduce their tendency to form aggregates. The dispersant coating ensures that the particle size distribution of the dispersant-coated carbon particles remains substantially constant with time, thereby stabilising the carbon particles. Current methods to form well-dispersed carbon black particles involve first reducing the carbon black particles in size by a method such as grinding, colloidal-milling, ball-milling, sand-milling and high-speed mixing, before adding dispersant and surfactant additives. However, in these processes, there is a high degree of mechanical contact with the particles which can damage or destroy the structure of the carbon particles and possibly introduce undesirable by-products. Furthermore, the dispersion times are relatively long and there is a lack of control over the size of the formed particles.

There is therefore a need to provide a process that overcomes or at least ameliorates one or more of the disadvantages described above.

### SUMMARY

According to a first aspect there is provided a process of making dispersant-coated carbon particles comprising the steps of:

(a) providing a liquid mixture comprising carbon particles and a dispersant; and

(b) imparting a shear force to the liquid mixture to thereby form said dispersant-coated carbon particles.

According to a second aspect there is provided a process of making dispersant-coated carbon particles comprising the steps of:

(a) providing a liquid mixture comprising carbon particles and a dispersant in a chamber comprising a packed bed; and

(b) rotating the chamber to pass the liquid mixture through the packed bed and thereby induce shear forces on the liquid mixture to form said dispersant-coated carbon particles.

According to a third aspect there is provided a suspension of dispersant-coated carbon particles made in a process comprising the steps of:

(a) providing a liquid mixture comprising carbon particles and a dispersant; and

(b) imparting a shear force to the liquid mixture to thereby form said suspension of dispersant-coated carbon particles.

According to a fourth aspect there is provided a dispersant-coated carbon powder made in a process comprising the steps of:

(a) providing a liquid mixture comprising carbon particles and a dispersant;

(b) imparting a shear force to the liquid mixture to thereby form dispersant-coated carbon particles; and

(c) removing the formed dispersant-coated carbon particles from the liquid to provide said dispersant-coated carbon powder.

### Definitions

The following words and terms used herein shall have the meaning indicated:

Unless specified otherwise, the terms “comprising” and “comprise”, and grammatical variants thereof, are intended to represent “open” or “inclusive” language such that they include recited elements but also permit inclusion of additional, unrecited elements.

The term “dispersant” or “dispersing agent” as used herein connotes a surface-active agent which promotes the uniform suspension or separation of nano-sized and/or micro-sized carbon particles. Suitable dispersants are taught in McCutcheon's Functional Materials, at pages 122-142 of the North American Edition (1994), as well as in McCutcheon's Functional Materials, at pages 47-56 of the International Edition (1994), both published by MC Publishing Company (McCutcheon Division) of Glen Rock, N.J.

The term “dispersant-coated carbon particles” as used herein refers to particles comprising an inner core of carbon surrounded by an outer coating comprising a dispersant.

The term “surfactant” as used herein relates to any composition that is capable of altering surface tension between the liquid of the liquid mixture and the carbon particles. Suitable Surfactants are taught in McCutcheon's Emulsifiers & Detergents, at pages 287-310 of the North American Edition (1994), and in McCutcheon's Emulsifiers & Detergents, at pages 257-278 and 280 of the International Edition (1994), both published by MC Publishing Co. (McCutcheon Division) of Glen Rock, N.J.

As used herein, the term “about”, in the context of concentrations of components of the formulations, typically means ±5% of the stated value, more typically ±4% of the stated value, more typically ±3% of the stated value, more typically, ±2% of the stated value, even more typically ±1% of the stated value, and even more typically ±0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

### Detailed Disclosure of Embodiments

Exemplary, non-limiting embodiments of a process of making dispersant-coated carbon particles will now be disclosed. The process comprises the steps of:

(a) providing a liquid mixture comprising carbon particles and a dispersant; and

(b) imparting a shear force to the liquid mixture to thereby form said dispersant-coated carbon particles.

The process may further comprise the step of:

(c) removing the formed dispersant-coated carbon particles from the liquid.

The removing step (c) may comprise the step of:

(c1) filtering the dispersant-coated carbon particles from the liquid mixture; and

(c2) drying the filtered dispersant-coated carbon particles.

The process may comprise the step of:

(d) maintaining, during the imparting step (b), the liquid mixture at a temperature within the range selected from the group consisting of about 0° C. to about 90° C., about 20° C. to about 70° C., about 10° C. to about 60° C., about 20° C. to about 50° C., about 30° C. to about 50° C., about 3° C. to about 95° C., about 3° C. to about 80° C., about 3° C. to about 70° C., about 3° C. to about 60° C., about 3° C. to about 50° C., about 3° C. to about 40° C., about 3° C. to about 50° C., about 3° C. to about 60° C., about 3° C. to about 70° C., about 3° C. to about 80° C., about 10° C. to about 95° C., about 20° C. to about 70° C., about 20° C. to about 95° C., about 30° C. to about 95° C., about 40° C. to about 95° C., about 50° C. to about 95° C., about 60° C. to about 95° C., about 70° C. to about 95° C., about 80° C. to about 95° C., about 20° C. to about 80° C., about 30° C. to about 70° C., and about 40° C. to about 60° C.

The process may comprise the step:

(e) reducing the size of the carbon particles before or during said imparting step (b). The reducing step (e) may comprise the step of:

(e1) passing the liquid mixture through a packed bed.

### Carbon Particles

The carbon particles may be carbon black particles. The carbon black particles may comprise amorphous carbon, graphite carbon or combinations thereof.

The carbon black particles may be selected from the group consisting of acetylene black, channel black, furnace black, lamp black, thermal black and combinations thereof.

The carbon black particles provided in step (a) may be nano-sized particles, micro-sized particles, or a combination thereof. The carbon black particles provided in step (a) may have a particle size range selected from the group consisting of: about 5 nm to about 1000 nm, about 5 nm to about 800 nm, about 5 nm to about 600 nm, about 5 nm to about 400 nm, about 5 nm to about 300 nm, about 5 nm to about 200 nm, about 5 nm to about 100 nm, about 5 to about 50 nm, about 10 nm to about 1000 nm, about 15 nm to about 1000 nm, about 50 nm to about 1000 nm, about 100 nm to about 1000 nm, about 500 nm to about 1000 nm, about 10 nm to about 300 nm, and about 20 nm to about 100 nm.

The carbon black particles may be obtained commercially from manufacturers such as Cabot Corporation of Boston, Mass., United States of America and Mitsubishi Chemical Corporation of Tokyo, Japan. Exemplary processes for making carbon black are disclosed in U.S. Pat. Nos. 6,827,772, 6,358,487 and 5,772,975.

### Dispersants

The selection of dispersant will be based on the desired properties of the dispersant-coated carbon particles. The dispersant may be a polymeric dispersant. The polymeric dispersant may include anionic, cationic, non-ionic polymeric dispersants or combinations thereof.

Anionic polymeric dispersants may include polymers comprising hydrophilic monomers, hydrophobic monomers, salts of such polymers or combinations thereof. Exemplary anionic hydrophilic monomers may include: styrene sulfonic acid, α,β-ethylenically unsaturated carboxylic acid, derivatives of α,β-ethylenically unsaturated carboxylic acid, acrylic acid, derivatives of acrylic acid, methacrylic acid, derivatives of methacrylic acid, maleic acid, derivatives of maleic acid, itaconic acid, derivatives of itaconic acid, fumaric acid, derivatives of fumaric acid or combinations thereof. Exemplary anionic hydrophobic monomers may include: styrene, styrene derivatives, vinyltoluene, vinyltoluene derivatives, vinylnaphthalene, vinylnaphthalene derivatives, butadiene, butadiene derivatives, isoprene, isoprene derivatives, ethylene, ethylene derivatives, propylene, propylene derivatives, alkylesters of acrylic acid, alkylesters of methacrylic acid or combinations thereof.

Exemplary salts of hydrophilic monomers and hydrophobic monomers may include: carboxymethyl-cellulose-sodium salt, alkali metal salts and onium compounds of ammonium ion, organic ammonium ion, phosphonium ion, sulfonium ion, oxonium ion, stibonium ion, stannonium ion and iodonium ion, carboxymethyl-cellulose-sodium salt or combinations thereof.

Additional exemplary anonic polymeric dispersants may include: poly(oxyethylene) group such as poly(oxyethylene)alkylether, or poly(oxypropylene) group such as poly(oxypropylene)alkyether(POAE), hydroxyl group, acrylamide, derivatives of acrylamide, (dimethyamino)ethylmethacrylate, ethoxyethyl methacrylate, butoxyethyl methacrylate, ethoxytriethylene methacrylate, methoxypolyethyleneglycol methacrylate, vinylpyrrolidone, vinylpyridine, vinyl alcohol, polyvinyl alcohol (PVA), alkyether or combinations thereof.

Cationic polymeric dispersants may be quaternary ammonium salts.

Nonionic polymeric dispersants may include poly(vinylpyrrolidone) (PVP), polypropylene glycol, vinylpyrrolidone-vinyl acetate copolymer or combinations thereof.

Additional exemplary dispersants may include naphthalenesulfonate, sodium naphthalenesulfonate, sodium naphthalenesulfonate polymer, sodium naphthalenesulfonate polymer with formaldehyde, alkylene oxide block co-polymer, sulfosuccinamate, octadecyl sulfosuccinamate, tetrasodium sulfonsuccinamate tricarboxilate, sodium sulfosuccinamate, bis-2-ethylhexyl sodium sulfosuccinate, tetrasodium N-(1,2-dicarboxyethye)-N-octadecyl sulfosuccinamate, sodium bis(tridecyl) sulfosuccinamate, poly-isobutene succinate, polyacrylic acid, sulfated alkyl-aryl ether, monester phosphate and diester phosphate, gelatin, poly-isobutene succinate, ammonium polyacrylate, poly(sodium acrylate), or combinations thereof.

The percentage weight of dispersant relative to the weight of carbon black particles present in the liquid mixture, may be in the weight range selected from the group consisting of: about 0.1 wt % to about 50 wt %, about 0.1 wt % to about 40 wt %, about 0.1 wt % to about 30 wt %, about 0.1 wt % to about 20 wt %, about 0.1 wt % to about 10 wt %, about 0.1 wt % to about 1 wt %, about 1 wt % to about 50 wt %, about 0.5 wt % to about 30 wt %, about 10 wt % to about 50 wt %, about 20 wt % to about 50 wt %, about 30 wt % to about 50 wt %, about 40 wt % to about 50 wt %.

### Liquid

It should be realised the selection of liquid will be based on the type of dispersant used and the solubility of that dispersant in the liquid. Ideally, the liquid should be chemically inert to the dispersant and the carbon particles. The liquid can be water, an organic liquid and combinations thereof. The organic liquid may be selected from the group consisting of hydrocarbons liquids, including saturated and unsaturated aromatic and aliphatic hydrocarbons. The hydrocarbon liquids, may be selected from the group consisting of alkanes, alkenes, alkynes, ketones, alcohols and halide hydrocarbons. Exemplary hydrocarbons include N-methyl-2-pyrolidinone, n-heptane, cyclohexane, decane, dodecane, methylnaphthalene, carbon tetrachloride, chloroform, 1-propanol, 2-propanol, or combinations thereof.

### Surfactants

The liquid mixture may comprise one or more surfactants. Exemplary surfactants include, but are not limited to, carboxymethyl-cellulose-sodium-salt, bis-2-ethylhexyl sodium sulfosuccinate, gelatin, poly-isobutene succinate, ammonium polyacrylate, poly(sodium acrylate), alkylaryl sulfonates, block polymers, carboxylated alcohol or alkylphenol ethoxylates, ethoxylated alcohols, ethoxylated alkylphenols, glycol esters, lignin and lignin derivatives, polyethylene glycols, silicone-based surfactants, sulfates and sulfonates ethoxylated alkylphenols, sulfonates of condensed naphthalenes, sulfonates of dodecyl and tridecylbenzenes, sulfonates of naphthalene and alkyl naphthalene, sulfosuccinamates, and sulfosuccinates and sulfosuccinate derivatives.

### Surface Modifying Agents

The liquid mixture may comprise one or more surface modifying agents. The surface modifying agents adsorb onto the particle surface and act as steric barriers to inhibit aggregation of the carbon particles. Exemplary surface modifying agents include, but are not limited to, a diphosphate, a polyphosphate, polyvinyl alcohol, polyvinylpyrrolidone, poly(oxyethylene/oxypropylene)alkyether and a methyl vinyl ether-maleic anhydride copolymer.

### Shear Force

In one embodiment, the liquid mixture is provided in a chamber comprising a packed bed. The imparting step (b) may comprise the step of:

(b1) passing the liquid mixture through the packed bed. The passing step (b1) may comprise passing the liquid mixture through the packed bed at an acceleration selected from the group consisting of: about 10 to 100,000 m²/s, about 10 to 80,000 m²/s, about 10 to 60,000 m²/s, about 10 to 40,000 m²/s, about 10 to 20,000 m²/s, about 10 to 10,000 m²/s, about 10 to 8,000 m²/s, about 15 to 6,000 m²/s, and about 20 to 5000 m²/s. The passing step (b1) may comprises the step of:

(b2) rotating the chamber to impart the sheer forces to the liquid mixture. The shear force may therefore be a centrifugal force imparted on the liquid as the chamber rotates.

The packed bed can be of any shape. Preferably, the packed bed is substantially cylindrical in shape and/or having at least one layer of packing.

The packing can be selected from the group consisting of: wire mesh, perforated plate, corrugated plate, foam packing and combinations thereof. The arrangement of the packing in the packed bed may be structured or random. The packing can be formed from a metallic material, a non-metallic material or combinations thereof.

It will be appreciated that there can be more than one packed beds provided within the chamber.

The size of the dispersant-coated carbon particles can be controlled by varying the magnitude of the centrifugal force acting on the liquid mixture. The centrifugal force can be controlled by adjusting the speed of rotation of the chamber.

The dispersant-coated carbon black particles formed in step (b) may be nano-sized particles, micro-sized particles, or a combination thereof. The dispersant-coated carbon black particles formed in step (b) may be larger in size than the carbon black particles provided in step (a). The dispersant-coated carbon black particles formed in step (b) may have a particle size range selected from the group consisting of: about 5 nm to about 500 nm, about 5 nm to about 400 nm, about 5 nm to about 300 nm, about 5 nm to about 200 nm, about 5 nm to about 100 nm, about 5 to about 50 nm, about 10 nm to about 500 nm, about 10 nm to about 250 nm, about 15 nm to about 500 nm, about 50 nm to about 500 nm, about 100 nm to about 500 nm, about 10 nm to about 300 nm, and about 100 nm to about 300 nm. It will be appreciated that the size of the dispersant-coated carbon black particles formed in step (b)

The particle size of the dispersant-coated carbon particles decreases as the magnitude of the centrifugal force increases. Accordingly in one embodiment, the process further comprises the step of varying the magnitude of the centrifugal force acting on the liquid mixture to control the particle size of the dispersant-coated carbon particles. It will be appreciated that the particle size of the dispersant-coated carbon particles will depend on the requirements of the various applications in which the dispersant-coated carbon particles are to be used.

### BRIEF DESCRIPTION OF DRAWINGS

The accompanying drawings illustrate a disclosed embodiment and serve to explain the principles of the disclosed embodiment. It is to be understood, however, that the drawings are designed for purposes of illustration only, and not as a definition of the limits of the invention.

FIG. 1A shows a SEM micrograph of 800 times magnification of carbon black powder used in Example 1 before dispersion.

FIG. 1B shows a SEM micrograph of 6025 times magnification of carbon black powder used in Example 1 before dispersion.

FIG. 2A shows a TEM micrograph of 120,000 times magnification of dispersed carbon black powder prepared in Example 1 in accordance with disclosed embodiment.

FIG. 2B shows a TEM micrograph of 80,000 times magnification of dispersed carbon black powder prepared in Example 1 in accordance with a disclosed embodiment.

FIG. 3 shows a schematic diagram of a rotating packed bed reactor.

FIG. 4 shows a particle size distribution of carbon black powder used in Example 1 before dispersion.

FIG. 5 shows a particle size distribution of dispersed carbon black powder prepared in Example 1.

### BEST MODE

A preferred embodiment of a process for forming dispersant-coated carbon particles is disclosed herein.

The process comprises the steps of providing a liquid mixture comprising carbon particles and a dispersant. The liquid mixture is subjected to shear forces to form dispersant-coated carbon particles.

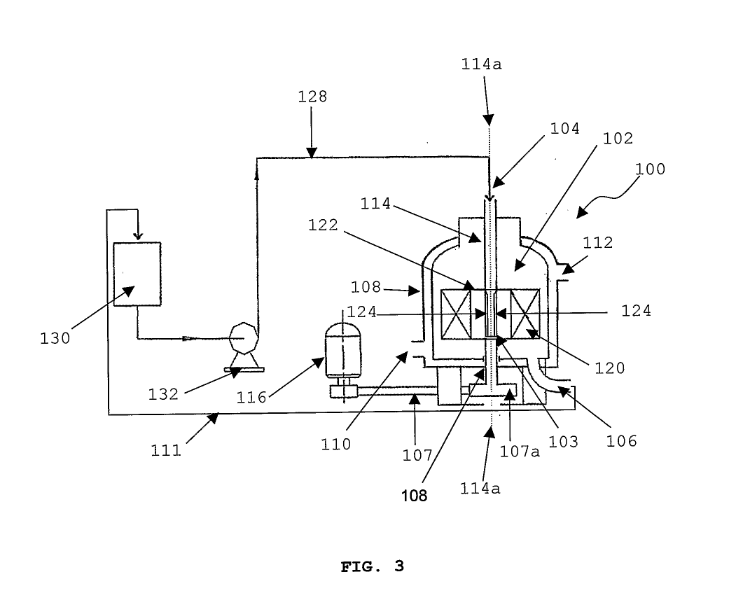

Referring to FIG. 3, there is shown a schematic diagram of a rotating packed bed reactor 100 which is suitable for carrying out the process for forming dispersant-coated carbon particles. The reactor 100 comprises a chamber 102 having a fixed hollow shaft 114 which extends vertically into the chamber 102. The hollow shaft 114 has a longitudinal axis 114a, a distal end 103 and a proximal feed inlet end 104 for allowing liquid feed material into the hollow shaft 114.

The reactor 100 also comprises an outlet 106 for allowing dispersant-coated carbon particles to be removed from the chamber 102.

A packed bed 120 is mounted onto the distal end 103 of the hollow shaft 114. The packed bed is driven by a motor 116 via a pulley 107 attached to the shaft 108 connected with the packed bed to rotate the shaft and the packed bed about the longitudinal axis 114a. The packed bed 120 is in fluid communication with the hollow shaft 114 via inlet slits 124.

The packed bed 120 is substantially cylindrical in shape and comprises a structured arrangement of a plurality of layers of wire mesh having a mesh size of 0.05 mm. The wire mesh is made from stainless steel.

A temperature jacket 108 surrounds the chamber 102 to regulate the temperature within the chamber 102. The temperature jacket 108 comprises a jacket inlet 110 for allowing heated fluid to enter and a jacket outlet 112 for allowing the fluid to exit from the jacket.

The proximal feed inlet 104 is linked by pipe 128 to a liquid feed tank 130 where the liquid mixture is stored. A pump 132 positioned along the pipe 128 pumps the liquid mixture from the storage tank to the reactor 100.

When in use, the liquid mixture is prepared in tank 130 by mixing defined quantities of liquid, dispersant and carbon black particles. Once prepared, the liquid mixture is fed into the chamber 102 via the proximal feed inlet 104 under action of the pump 132.

Upon entry into the hollow shaft 114, the liquid mixture is channelled toward the inlet slits 124 and through the packed bed 120 as the packed bed 120 rotates about the longitudinal axis 114a. In the packed bed 120, the liquid mixture is subjected to high shear forces in the form of centrifugal forces created by the relative rotational motion of the packed bed 120 and the hollow shaft 114 about the longitudinal axis 114a.

The magnitude of the centrifugal forces exerted on the liquid mixture within the packed bed 120 is dependent on the speed of rotation of the packed bed 120. The centrifugal forces drive the liquid mixture radially outwards within the packed bed 120. The packing mesh within the packed bed 120 cuts and divides the carbon particles in the liquid mixture into smaller particle sizes, thereby increasing the surface area on which the dispersant, present in the liquid mixture, can coat the carbon particles.

The dispersant coats the fine carbon particles to form dispersant-coated carbon particles. The dispersant imparts surface charge to the carbon particles, which results in electrostatic, steric or electrosteric repulsion between the dispersant-coated carbon particles. The electrostatic, steric or electrosteric repulsion between the dispersant-coated carbon particles reduces or eliminates the aggregation of the particles. Furthermore, because the dispersant-coated carbon particles do not aggregate, they have a narrower particle size distribution which remains substantially constant with time, and are therefore more stable. During dispersion, the liquid mixture, after passing through the packed bed 120, exits outlet 106 and passes through pipe 111 and into the liquid feed tank 130 where it is pumped into the reactor 100 again for continuous dispersion. This is repeated until the pre-set dispersion time expires.

The dispersant-coated carbon particles suspended in the liquid are removed from the chamber 102 via product outlet 106. Thereafter, the suspended dispersant-coated carbon particles can be removed from the liquid by first being subjected to filtering and then subsequent drying in an oven to obtain dry powder of dispersant-coated carbon black powder.

### EXAMPLES

Non-limiting examples of the invention, including the best mode, will be further described in greater detail by reference to specific Examples, which should not be construed as in any way as limiting the scope of the invention.

### Example 1

A liquid mixture containing 300 g of carbon black powder of particle size 50 nm, 50 g of polyvinyl alcohol dispersant (PVA) and 2000 g of water, was fed into the tank 130 of FIG. 3 and then passed through the packed bed 120 via hollow shaft 114. The temperature of the chamber 102 was set to 50° C. by maintaining the fluid temperature in the jacket 108 at this temperature.

The reactor 100 was operated in batch mode, wherein the liquid mixture is continuously passed through the packed bed for a pre-set dispersion time period. The liquid mixture, upon passing through the packed bed 120, exits through pipe 111 and flows into the liquid feed tank 130 to be pumped into reactor 100 again for continuous dispersion.

The packed bed 120 was rotated by the motor 116 at a speed of 1500 rpm to achieve centrifugal acceleration of 4500 m/s² within the packed bed 120.

The total dispersion time was 3 hours. At the end of the 3 hour period, the pump 132 and motor 116 were turned off and the outlet 106 was opened to release the liquid mixture containing the dispersant-coated carbon particles from the chamber 102. The average size of the dried dispersant-coated carbon particles was about 180 nm.

The dispersant-coated carbon particles can be filtered and then dried in an oven at 100° C. for 8 hours to obtain a dry dispersant-coated carbon particles. The average size of the dispersant-coated carbon particles was the same as the particle size in the above slurry.

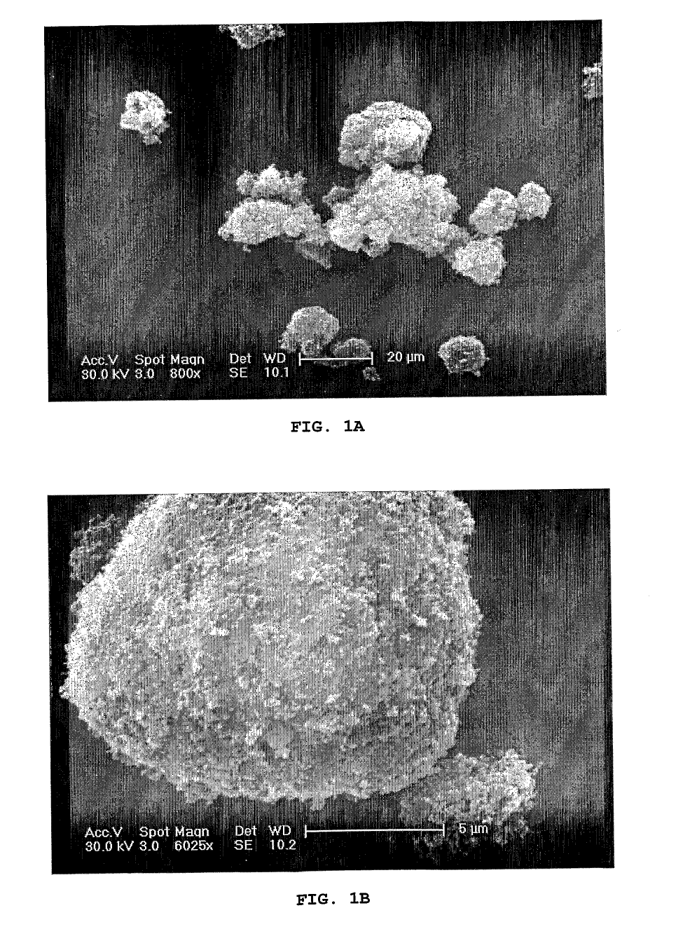

A Scanning Electron Microscope (SEM) micrograph of 800 times magnification of the carbon black particles before the dispersion coating was applied is shown in FIG. 1A. FIG. 1B shows a further magnification of the carbon black particles, that is, 6025 times magnification, before the dispersion coating was applied. The sample of carbon black particles as shown in the micrographs were prepared from 0.05 g of carbon black particles that were first dispersed in ethanol and then subjected to ultra-sonification for about 5 minutes. The micrographs were taken with a JSM-6700 model Scanning Electron Microscope. It can be seen from FIGS. 1A and 1B that carbon black particles, prior to dispersion coating, form aggregates and have a wide particle size distribution.

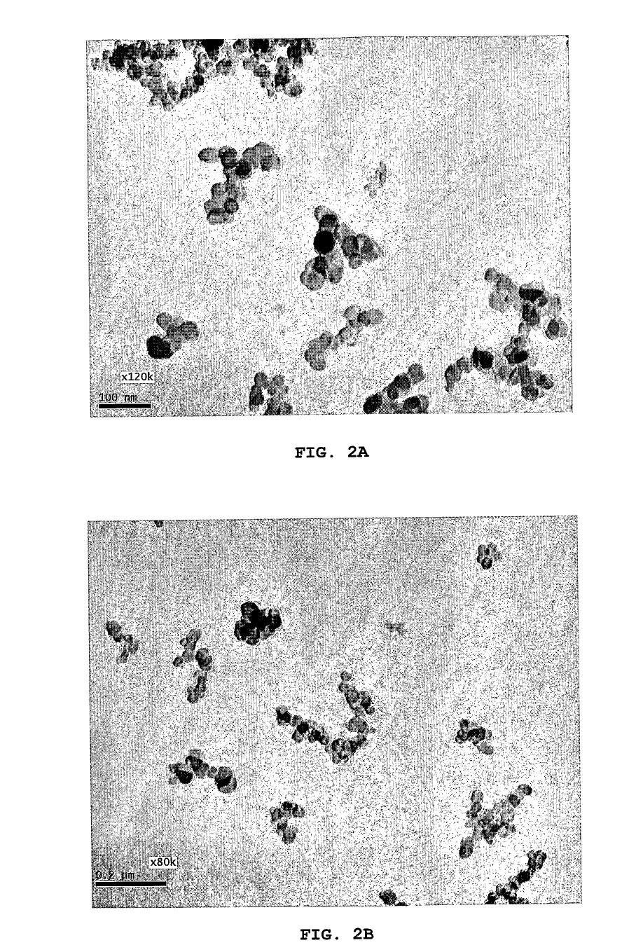

A Transmission Electron Microscope (TEM) micrograph of 80,000 times magnification of the dispersant-coated carbon black particles prepared in this Example is shown in FIG. 2B. FIG. 2A shows a 120,000 times magnification of the dispersant-coated carbon black particles prepared in this example. The micrographs were taken with a HITACHI-800 model Transmission Electron Microscope. It can be seen from FIGS. 2A and 2B that the dispersant-coated carbon black particles exhibit enhanced dispersion as aggregation of the carbon particles is not observed.

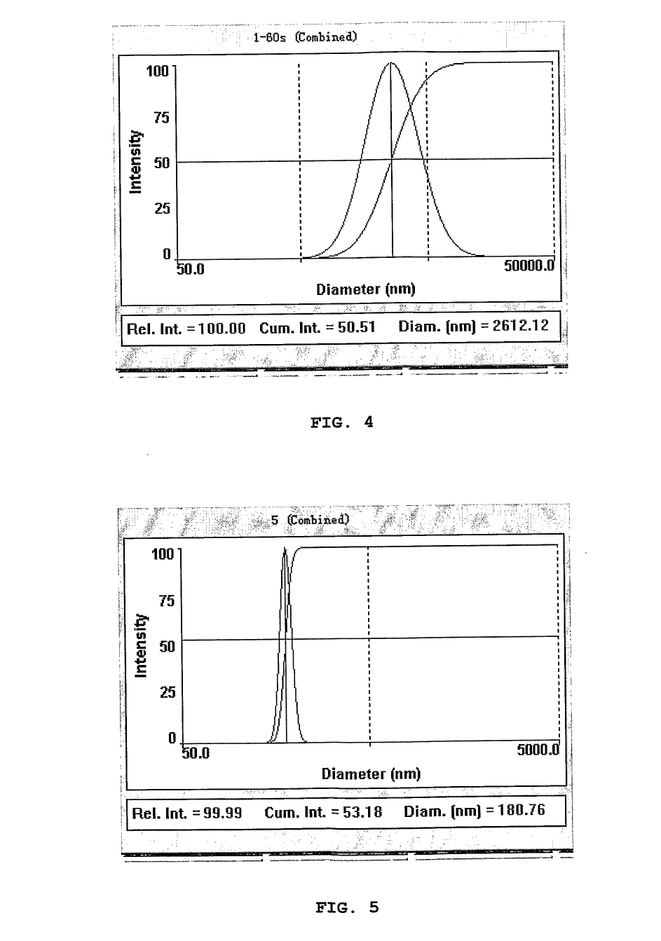

FIG. 4 shows the particle size distribution of carbon black particles in the liquid mixture before coating with a dispersant. The readings were obtained with ZETAPLUS Laser Diffracting Sizing equipment. The Laser Diffracting Sizing Equipment also provides a half width reading which is an indication of the standard deviation of the particle size distribution. A large average particle size of 2700 nm having a half width of 553 nm was observed. The high half width reading indicated a wide particle size distribution for these particles. FIG. 5 shows the particle size distribution of the dispersant-coated carbon black particles prepared in this Example. The readings were obtained with ZETAPLUS Laser Diffracting Sizing equipment. A smaller average particle size of 180 nm having a half width reading of 15.1 mm was observed. The low half width reading indicate a narrower particle size distribution

Accordingly, the process of the present invention forms dispersant-coated carbon particles that are stable, exhibit less inclination to aggregate and form clusters of larger particles, and have a narrow particle size distribution.

### Example 2

A liquid mixture containing 300 g of carbon black powder of particle size 50 nm, 80 g of polyvinyl alcohol dispersant (PVA) and 3000 g of N-methyl-2-pyrrolidinone (NMP), was prepared in tank 130 before being fed to the chamber 102 of the rotating packed bed reactor 100. The reactor 100 was operated in batch mode as in Example 1, with the exception that the temperature within the chamber 102 was to 25° C. and centrifugal acceleration was set to 3000 m/s². The total dispersion time was 3.0 hours.

The average size of the dispersant-coated particles was measured to be around 160 nm having a half width of 13.2 nm.

### Example 3

A mixture containing 350 g of carbon black powder of particle size 25 nm, 50 g of poly(oxyethylene/oxypropylene) alkylether dispersant (POAE) and 4000 g of N-methyl-2-pyrrolidinone (NMP), was prepared in tank 130 before being fed to the chamber 102 of the rotating packed bed reactor 100. The reactor 100 was operated in batch mode under the same conditions as in Example 2. The total dispersion time was 3.0 hours.

The average size of the dispersant-coated particles was measured to be around 140 nm having a half width of 12.3 nm.

### Example 4

A mixture containing 350 g of carbon black powder of particle size 25 nm, 50 g of poly(oxyethylene/oxypropylene) alkylether dispersant (POAE) and 4000 g of N-methyl-2-pyrrolidinone (NMP), was prepared in tank 130 before being fed to the chamber 102 of the rotating packed bed reactor 100. The reactor 100 was operated in batch mode under the same conditions as in Example 3, with the exception that the temperature within the chamber 102 was set to 70° C. The total dispersion time was 3.0 hours.

The average size of the dispersant-coated particles was measured to be around 120 nm having a half width of 10.2 nm.

### Example 5

A mixture containing 350 g of carbon black powder of particle size 25 nm, 25 g of polyvinylpyrrolidone (PVP) dispersant and 25 g of poly(oxyethylene/oxypropylene) alkylether dispersant (POAE), was prepared in tank 130 before being fed to the chamber 102 of the rotating packed bed reactor 100. The reactor 100 was operated in batch mode under the same conditions as in Example 3. The total dispersion time was 3.0 hours.

The average size of the dispersant-coated particles was measured to be around 120 nm having a half width of 10.4 nm.

### Example 6

A mixture containing 350 g of carbon black powder of particle size 25 nm, 50 g of poly(oxyethylene/oxypropylene) alkylether dispersant (POAE) and 4000 g of N-methyl-2-pyrrolidinone (NMP), was prepared in tank 130 before being fed to the chamber 102 of the rotating packed bed reactor 100. The reactor 100 was operated in batch mode under the same conditions as in Example 3, with the exception that the temperature within the chamber 102 was set to 70° C. The total dispersion time was 2.0 hours.

The average size of the dispersant-coated particles was measured to be around 140 nm having a half width of 12.5 nm.

### Applications

It should be appreciated that the process is not limited to carbon black particles but can be used to disperse other types of carbon particles.

It will be appreciated that the dispersant-coated carbon particles resulting from the process are stable and have a narrow particle size distribution. The shear force that is applied to the liquid mixture cuts and divides the aggregates of carbon particles into smaller particles thereby increasing the surface area on which the dispersant can coat thereon. The dispersant coating imparts surface charge to the carbon particles which results in electrostatic repulsion between the particles and thus discourages formation of aggregates.

It will be appreciated that the particle size of the dispersant-coated carbon particles can be controlled by varying the acceleration of the shear force imparted to the liquid mixture. Accordingly, dispersant-coated carbon particles of desired sizes for the required applications can be achieved.

It will be appreciated that the process involves less mechanical contact between the carbon particles and the packings in the packed bed when compared to conventional dispersion methods involving grinding, milling and high speed mixing. Accordingly, minimal structural damage to the carbon particles is achieved.

It will be appreciated that the process can produce dispersant-coated particles in a relatively short period of time when compared with conventional dispersion methods. This is due to the high shear force that is applied to the liquid mixture to drive the mixture through the packed bed at high speeds.

It will be appreciated that the capacity of the process can be scaled up to form larger quantities of dispersant-coated carbon particles, without affecting the stability and the particle size distribution of the product.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A process of making dispersant-coated carbon particles comprising the steps of:
(a) providing a liquid mixture comprising carbon particles and a dispersant; and
(b) imparting a shear force to the liquid mixture to thereby form said dispersant-coated carbon particles.

2. A process as claimed in claim 1, wherein said providing step (a) comprises the step of:
(a1) providing the liquid mixture in a chamber comprising a packed bed.

3. A process as claimed in claim 2, wherein said imparting step (b) comprises the step of:
(b1) rotating the packed bed to pass the liquid mixture through the packed bed and thereby induce shear forces on the liquid mixture.

4. A process as claimed in claim 1, comprising the step of
(c) removing the formed dispersant-coated carbon particles from the liquid.

5. A process as claimed in claim 4, wherein said removing step (c) comprises the steps of:
(c1) filtering the dispersant-coated carbon particles from the liquid mixture; and
(c2) drying the filtered dispersant-coated carbon particles.

6. A process as claimed in claim 1, wherein the carbon particles are carbon black particles selected from the group consisting of acetylene black, channel black, furnace black, lamp black, thermal black and combinations thereof.

7. A process as claimed in claim 1, wherein the dispersant-coated carbon particles are nano-sized particles, micro-sized particles, or a combination thereof.

8. A process as claimed in claim 2, wherein the imparting step (b) comprises the step of:
(b2), passing the liquid mixture through the packed bed at an acceleration selected from the group consisting of: about 10 to 100,000 m²/s, about 10 to 80,000 m²/s, about 10 to 60,000 m²/s, about 10 to 40,000 m²/s, about 10 to 20,000 m²/s, about 10 to 10,000 m²/s, about 10 to 8,000 m²/s, about 15 to 6,000 m²/s, and about 20 to 5000 m²/s.

9. A process as claimed in claim 1, further comprising the step of:
(d) varying the magnitude of the shear force acting on the liquid mixture to control the particle size of the dispersant-coated carbon particles.

10. A process as claimed in claim 1, wherein the providing step (a) comprises the step of:
(a2) providing a surfactant with the liquid mixture.

11. A process as claimed in claim 1, wherein said providing step (a) comprises the step of:
(a2) providing an amount of the dispersant relative to the weight of carbon particles, in a weight percentage amount selected from the group consisting of: about 0.1 wt % to about 50 wt %, about 0.1 wt % to about 40 wt %, about 0.1 wt % to about 30 wt %, about 0.1 wt % to about 20 wt %, about 0.1 wt % to about 10 wt %, about 0.1 wt % to about 1 wt %, about 1 wt % to about 50 wt %, about 0.5 wt % to about 30 wt %, about 10 wt % to about 50 wt %, about 20 wt % to about 50 wt %, about 30 wt % to about 50 wt %, about 40 wt % to about 50 wt %.

12. A process as claimed in claim 1, wherein the dispersant is a polymeric dispersant.

13. A process as claimed in claim 12, wherein the polymeric dispersant is selected from the group consisting of: an anionic polymeric dispersant, a cationic polymeric dispersant, a non-ionic polymeric dispersant, and combinations thereof.

14. A process according to claim 13, wherein the anionic polymeric dispersant is selected from the group consisting of: polymers comprising hydrophilic monomers, polymers comprising hydrophobic monomers, salts of such polymers, and combinations thereof.

15. A process as claimed in claim 1, wherein the liquid of the liquid mixture is selected from the group consisting of: water, liquid hydrocarbons and mixtures thereof.

16. A process as claimed in claim 15, wherein the liquid hydrocarbons are selected from the group consisting of: N-methyl-2-pyrolidinone, n-heptane, cyclohexane, decane, dodecane, methylnaphthalene, carbon tetrachloride, chloroform, 1-propanol, 2-propanol, and combinations thereof.

17. A process as claimed in claim 1, wherein the particle size of the dispersant coated carbon particles is selected from the group consisting of: about 5 nm to about 500 nm, about 5 nm to about 400 nm, about 5 nm to about 300 nm, about 5 nm to about 200 nm, about 5 nm to about 100 nm, about 5 to about 50 nm, about 250 nm, about 15 nm to about 500 nm, about 50 nm to about 500 nm, about 100 nm to about 500 nm, about 10 nm to about 300 nm, and about 100 nm to about 300 nm.

18. A process as claimed in claim 2, wherein the packing of the packed bed is selected from the group consisting of: wire mesh, perforated plate, corrugated plate, foam packing and combinations thereof.

19. A process as claimed in claim 1, comprising the step of:
(e) reducing the size of the carbon particles before or during said imparting step (b).

20. A process as claimed in claim 2, comprising the step of:
(f) reducing the size of the carbon particles before or during said imparting step (b), by passing the liquid mixture through the packed bed.

21. A process as claimed in claim 1, wherein said liquid mixture is maintained at a temperature selected from the group consisting of about 3° C. to about 95° C., about 10° C. to about 95° C., about 20° C. to about 95° C., about 20° C. to about 95° C., about 30° C. to about 95° C., about 40° C. to about 95° C., and about 40° C. to about 80° C.

22. A process as claimed in claim 1, wherein the providing step (a) comprises the step of:
(a3) providing a surface modifying agent with the liquid mixture.

23. A suspension of dispersant coated carbon particles obtained from the process of claim 1.

24. A dispersant-coated carbon powder obtained from the process according to claim 1.
